(19) United States
(12) Patent Application Publication
(10) Pub. No.: US 2022/0237144 A1
(43) Pub. Date: Jul. 28, 2022

(54) BASEBOARD MANAGEMENT CONTROLLER AND CONSTRUCTION METHOD THEREOF

(71) Applicant: INSPUR SUZHOU INTELLIGENT TECHNOLOGY CO., LTD., Suzhou (CN)

(72) Inventors: Xiaofeng ZOU, Suzhou (CN); Tongqiang LIU, Suzhou (CN); Yulong ZHOU, Suzhou (CN)

(21) Appl. No.: 17/595,978

(22) PCT Filed: Sep. 29, 2021
(86) PCT No.: PCT/CN2019/108978

§ 371 Date: Nov. 30, 2021

(30) Foreign Application Priority Data
Aug. 9, 2019 (CN) 201910734857.9

(51) Int. Cl. G06F 15/78; G06F 13/42

(52) U.S. Cl. CPC G06F 15/78; G06F 13/4282

(57) ABSTRACT

Disclosed is a baseboard management controller constructed based on RISC-V system architecture, wherein the baseboard management controller includes a processor, a memory and a peripheral interface that are connected by an AXI bus; wherein, the memory is configured to store an OpenBMC system which is obtained by cross-compiling of an OpenBMC software framework by an RISC-V tool chain of the RISC-V architecture; the processor is configured to execute the OpenBMC system stored in the memory, and the soft core source code of the processor is generated by a RocketChip generator. The baseboard management controller is constructed based on the open source RISC-V system architecture instead of the ARM architecture. As a result, the baseboard management controller used by the user is no longer limited by the manufacturer, and the user can completely autonomously control the baseboard management controller that he/she uses.

### CROSS-REFERENCE TO RELATED APPLICATIONS

This application is a 371 of International Patent Application Number PCT/CN2019/108978, filed on Sep. 29, 2019, which claims the benefit and priority of Chinese Patent Application Number 201910734857.9, filed on Aug. 9 2019 with China National Intellectual Property Administration, the disclosures of which are incorporated herein by reference in their entireties.

### TECHNICAL FIELD

The present disclosure relates to the technical field of server system management, in particular to a baseboard management controller and a construction method thereof.

### BACKGROUND

Baseboard management controller (BMC) is one of the core components of a server. It is usually implemented as an ASIC on a southbridge of a mainboard of the server and mainly implements the system-wide management control function of the server.

The BMC used in the current server is implemented based on the ARM architecture. The ARM architecture has been granted intellectual property rights, so not only is the existing BMC costly, but also the security cannot be effectively guaranteed. Moreover, the ARM architecture can be used only after being authorized, so if manufacturers implement technical control on the ARM architecture, it will have a serious impact on the server and embedded industries.

Therefore, the BMC used by the user is limited by the manufacturer, and the user cannot completely autonomously control the BMC that he/she uses.

### SUMMARY

Based on the above-mentioned shortcomings of the prior art, the present disclosure provides a baseboard management controller and a construction method thereof to solve the problem that the baseboard management controller used by the user is limited by the manufacturer and the user cannot completely autonomously control the baseboard management controller that he/she uses.

In order to achieve the above objectives, the present disclosure provides the following technical solutions:

the first aspect of the present disclosure provides a baseboard management controller, which is constructed based on RISC-V system architecture, wherein the baseboard management controller includes a processor, a memory and a peripheral interface that are connected by an AXI bus;

wherein, the memory is configured to store an OpenBMC system which is obtained by cross-compiling of an OpenBMC software framework by an RISC-V tool chain of the RISC-V architecture;

the processor is configured to execute the OpenBMC system stored in the memory, and a soft core source code of the processor is generated by a RocketChip generator.

Optionally, in the above-mentioned baseboard management controller, the peripheral interface includes a two-wire serial bus interface I2C, a universal serial bus interface USB, a video transmission interface VGA, an Ethernet interface Ethernet, and a high-speed serial computer expansion bus interface PCIE.

Optionally, in the above-mentioned baseboard management controller, the memory includes an SPI memory of the RISC-V system architecture.

Optionally, in the above-mentioned baseboard management controller, a start-up mode of the OpenBMC system is set as an SPI mode.

Optionally, in the above-mentioned baseboard management controller, the start-up mode of the OpenBMC system being the SPI mode is obtained by modifying RISC-V start-up firmware of the RISC-V system architecture.

Another aspect of the present disclosure provides a construction method of a baseboard management controller, including:

setting up a runtime environment of a RocketChip generator and processing configuration information using the RocketChip generator in the runtime environment that is set up to generate a soft core source code of the processor; wherein the configuration information is configuration information of the processor;

configuring a peripheral interface based on the soft core source code of the processor; wherein the peripheral interface is connected with the processor through an AXI bus;

setting up a development environment of an OpenBMC software framework, and performing cross compiling on the OpenBMC software framework using an RISC-V tool chain of the RISC-V architecture to obtain an OpenBMC system; and

refreshing the OpenBMC system to a memory.

Optionally, in the above-mentioned construction method of a baseboard management controller, refreshing the OpenBMC system to a memory includes: [0021] refreshing the OpenBMC system to an SPI memory of the RISC-V system architecture.

Optionally, in the above-mentioned construction method of a baseboard management controller, the peripheral interface includes a two-wire serial bus interface I2C, a universal serial bus interface USB, a video transmission interface VGA, an Ethernet interface Ethernet, and a high-speed serial computer expansion bus interface PCIE.

Optionally, in the above-mentioned construction method of a baseboard management controller, after performing cross compiling on the OpenBMC software framework using an RISC-V tool chain of the RISC-V architecture to obtain an OpenBMC system, the construction method further includes:

setting a startup mode of the OpenBMC system as an SPI mode.

Optionally, in the above-mentioned construction method of a baseboard management controller, setting a startup mode of the OpenBMC system as an SPI mode includes:

modifying RISC-V startup firmware of the RISC-V system architecture to enable a startup mode of the OpenBMC system to be an SPI mode.

According to the baseboard management controller and the construction method thereof provided by the present disclosure, the baseboard management controller is constructed based on open source RISC-V system architecture, and the constructed baseboard management controller includes a processor, a memory, and a peripheral interface that are connected by an AXI bus; wherein, the memory is configured to store an OpenBMC system which is obtained by cross-compiling of an OpenBMC software framework by an RISC-V tool chain of the RISC-V architecture; the processor is configured to execute the OpenBMC system stored in the memory, and the soft core source code of the processor is generated by a RocketChip generator. The baseboard management controller is constructed based on the open source RISC-V system architecture instead of the ARM architecture. As a result, the baseboard management controller used by the user is no longer limited by the manufacturer, and the user can completely autonomously control the baseboard management controller that he/she uses.

### BRIEF DESCRIPTION OF THE DRAWINGS

In order to more clearly illustrate the technical solutions in the embodiments of the present disclosure or the prior art, the embodiments or the drawings needed in the description of the prior art will be briefly introduced below. Obviously, the drawings in the following description are only embodiments of the present disclosure. For those of ordinary skill in the art, other drawings can also be obtained based on the provided drawings without paying creative work.

FIG. 1 is a structural schematic diagram of a baseboard management controller provided by an embodiment of the present disclosure;

FIG. 2 is a structural schematic diagram of a baseboard management controller provided by another embodiment of the present disclosure;

FIG. 3 is a layered structural schematic diagram of a baseboard management controller provided by an embodiment of the present disclosure; and

FIG. 4 is a flow diagram of a construction method of a baseboard management controller provided by another embodiment of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure.

In this application, the terms “including”, “include” or any other variants thereof are intended to cover non-exclusive inclusion, so that a process, method, article or device including a series of elements not only includes those elements, but also includes other elements that are not clearly listed, or also include elements inherent to this process, method, article, or device. Without more restrictions, the element defined by the sentence “including a . . . ” does not exclude the existence of other identical elements in the process, method, article, or device that includes the element.

The embodiment of the present disclosure provides a baseboard management controller constructed based on RISC-V system architecture, as shown in FIG. 1, including:

a processor 101, a memory 102 and a peripheral interface 103 that are connected by an AXI bus.

It should be noted that the RISC-V system architecture is open source instruction set architecture designed and released by the University of California, Berkeley. Since the RISC-V system architecture is open source, compared to other patent system architecture, such as ARM architecture, x86 architecture, MIPS architecture and Alpha architecture, using the RISC-V system architecture by users does not need to bear high costs and does not require authorization, thus facilitating innovation. Therefore, the baseboard management controller provided by the embodiment of the present disclosure is constructed based on the open source RISC-V system architecture.

Wherein, the memory 102 is configured to store an OpenBMC system which is obtained by cross-compiling of an OpenBMC software framework by an RISC-V tool chain of the RISC-V architecture.

It should be noted that the OpenBMC software framework is an open source software framework used to construct a complete Linux operating system image of the baseboard management controller. Thus, the operating system of the baseboard management controller can be obtained by compiling the OpenBMC system.

It should also be noted that cross compiling can be understood as compared to native compiling. Cross compiling can be popularly understood as compiling programs that run on other platforms under the current platform. Because the OpenBMC system compiled on the local development platform needs to run on the baseboard management controller, not on the local development platform. Therefore, the OpenBMC software framework needs to be compiled on the local development platform through the cross-compiling tool chain to obtain the OpenBMC system that can run on the baseboard management controller.

Specifically, since the baseboard management controller in the embodiment of the present disclosure is constructed based on the RISC-V system architecture, the operating system should perform cross compiling through the RISC-V tool chain, that is, the operating system performs cross compiling on the OpenBMC software framework through the RISC-V tool chain to obtain the OpenBMC system, and the OpenBMC system is refreshed to the memory 102 of the baseboard management controller.

Optionally, in this embodiment of the present disclosure, the memory 102 of the baseboard management controller adopts an SPI memory. Therefore, specifically, the completely compiled OpenBMC system is refreshed to the SPI memory of the RISC-V system architecture.

Optionally, in another embodiment of the present disclosure, the startup mode of the OpenBMC system is set as an SPI mode. Specifically, by modifying RISC-V startup firmware of the RISC-V system architecture, the startup mode of the OpenBMC system is set as an SPI mode.

Specifically, the OpenBMC system includes a Linux operating system kernel. Management interface service programs, built-in IPMI management applications, system firmware, bootloaders at all stages and other management protocols and applications all run on the Linux operating system kernel of the OpenBMC system.

In the embodiment of the present disclosure, the processor 101 of the baseboard management controller is configured to execute the OpenBMC system stored in the memory 102, and a soft core source code of the processor 101 is generated by a RocketChip generator.

Wherein, the RocketChip generator is a processor 101 source code generator developed by the University of California, Berkeley based on an RISC-V reduced instruction set, and the generator is written in Chisel language.

Therefore, in the embodiment of the present disclosure, an environment of the RocketChip generator is set up, and the source code provided by the RocketChip generator is modified to perform corresponding configuration, thereby generating the soft core source code of the processor 101 based on the RISC-V reduced instruction set.

The baseboard management controller usually has a two-wire serial bus interface I2C, a universal serial bus interface USB, a video transmission interface VGA, an Ethernet interface Ethernet, and a high-speed serial computer expansion bus interface PCIE and other abundant peripheral interfaces, therefore, the peripheral interface 103 configured by the baseboard management controller in another embodiment of the present disclosure also includes: a two-wire serial bus interface I2C, a universal serial bus interface USB, a video transmission interface VGA, an Ethernet interface Ethernet, and a high-speed serial computer expansion bus interface PCIE.

It should be noted that the baseboard management controller in the embodiment of the present disclosure is provided with the above-mentioned several interfaces, because these peripheral interfaces are the more commonly used interfaces in the baseboard management controller. However, the baseboard management controller is not limited to only being provided with the above-mentioned peripheral interfaces. It is also possible to set only some of the above-mentioned peripheral interfaces in the baseboard management controller according to actual needs, or set more peripheral interfaces, which all belong to the protection category of the present disclosure.

Specifically, a two-wire serial bus interface I2C, a universal serial bus interface USB, a video transmission interface VGA, an Ethernet interface Ethernet, and a high-speed serial computer expansion bus interface PCIE are added to the AXI bus of the baseboard management controller, and moreover, drivers for the peripheral interfaces are required to be added accordingly at the same time.

Optionally, the generated soft core source code of the processor 101 can be mapped to a field programmable gate array (FPGA) chip to implement the processor 101 of the baseboard management controller, and a two-wire serial bus interface I2C, a universal serial bus interface USB, a video transmission interface VGA, an Ethernet interface Ethernet, and a high-speed serial computer expansion bus interface PCIE and other peripheral interfaces can be added into the FPGA.

Optionally, in another embodiment of the present disclosure, the baseboard management controller may further include a trusted security verification module and firmware. The trusted security verification module is configured to verify the legality of the data and protect the safe operation of the baseboard management controller.

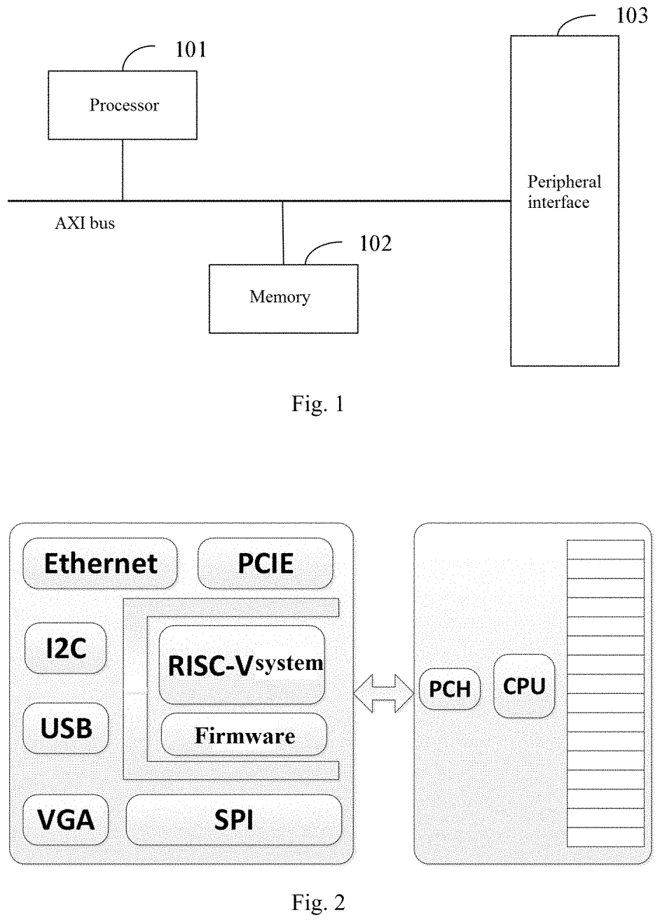

Therefore, the baseboard management controller in the embodiment of the present disclosure, as shown in FIG. 2, from an architectural point of view, specifically includes: an RISC-V system carried on a processor and implemented based on an RISC-V system, and its corresponding firmware, the SPI memory storing the OpenBMC system, and a two-wire serial bus interface I2C, a universal serial bus interface USB, a video transmission interface VGA, an Ethernet interface Ethernet, and a high-speed serial computer expansion bus interface PCIE. In addition, the baseboard management controller is also connected to the southbridge PCH of the server to manage the hardware system of the server.

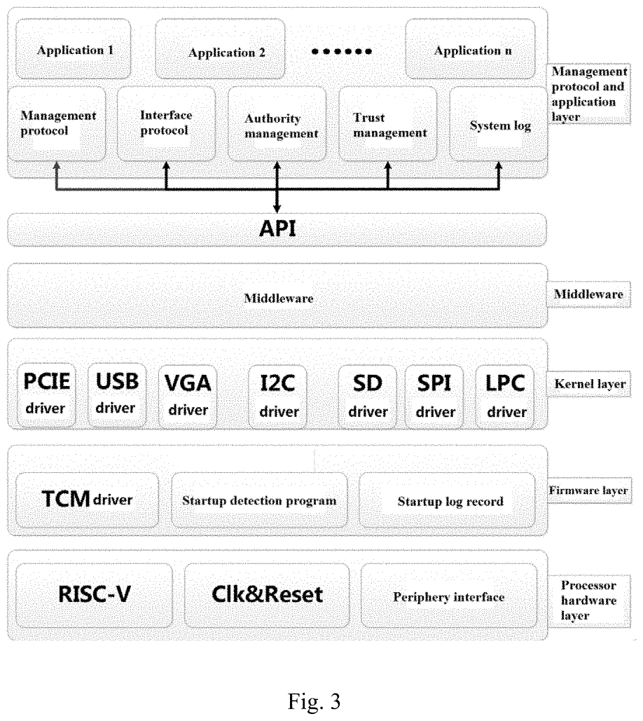

It should also be noted that the baseboard management controller provided in the embodiment of the present disclosure, as shown in FIG. 3, can be divided into a management protocol and application layer, a kernel layer, middleware, a firmware layer and a processor 101 hardware layer according to a software layering mechanism. Wherein, the management protocol and application layer includes various applications running on the Linux operating system kernel of the OpenBMC system, management interface service programs, and built-in IPMI management applications. The kernel layer mainly includes the Linux operating system kernel of the OpenBMC system and the driver of the peripheral interface 103. The firmware layer mainly includes the startup process management and kernel bootstrap programs during the startup process of the baseboard management controller, and the built-in trusted security verification module. The processor 101 hardware layer mainly includes a soft core source code based on the RISC-V system architecture and peripheral modules such as a peripheral interface 103.

The baseboard management controller provided by the embodiment of the present disclosure is constructed based on the open source RISC-V system architecture, and the constructed baseboard management controller includes: a processor 101, a memory 102 and a peripheral interface 103 that are connected by an AXI bus; wherein, the memory 102 is configured to store an OpenBMC system which is obtained by cross-compiling of an OpenBMC software framework by an RISC-V tool chain of the RISC-V architecture; the processor 101 is configured to execute the OpenBMC system stored in the memory 102, and the soft core source code of the processor 101 is generated by a RocketChip generator. The baseboard management controller is constructed based on the open source RISC-V system architecture instead of the ARM architecture, so that the baseboard management controller used by the user is no longer limited by intellectual property rights, and the user can completely autonomously control the baseboard management controller that he/she uses. In addition, the cost of the baseboard management controller is greatly reduced.

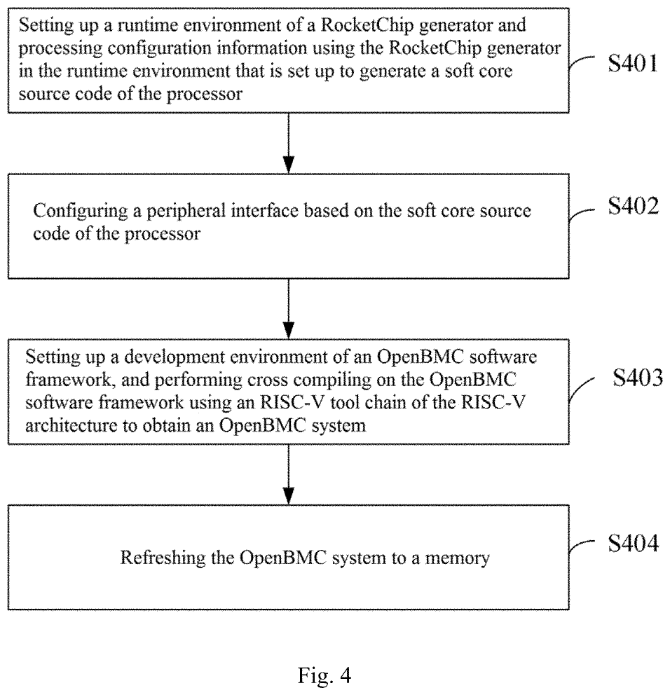

Another embodiment of the present disclosure also provides a construction method of a baseboard management controller, as shown in FIG. 4, including:

S401, setting up a runtime environment of a RocketChip generator and processing configuration information using the RocketChip generator in the runtime environment that is set up to generate a soft core source code of the processor.

Wherein, the configuration information is configuration information of the processor.

Specifically, a runtime environment of a RocketChip generator is set up on the local development platform or device, and the source code and kernel configuration provided by the RocketChip generator are modified and the parameter attributes such as multi-core are added in the runtime environment that is set up using the RocketChip generator to generate a superscalar out-of-order execution kernel RTL source code. Wherein, the generated superscalar out-of-order execution kernel RTL source code is the soft core source code of the processor.

S402, configuring a peripheral interface based on the soft core source code of the processor.

Wherein, the peripheral interface is connected with the processor through the AXI bus.

Optionally, the configured peripheral interface includes a two-wire serial bus interface I2C, a universal serial bus interface USB, a video transmission interface VGA, an Ethernet interface Ethernet, and a high-speed serial computer expansion bus interface PCIE.

Wherein, the high-speed serial computer expansion bus interface PCIE can be used to be connected with the southbridge PCH of the server to realize the interconnection between the baseboard management controller and the server, so that the baseboard management controller can manage and control hardware of the server. Therefore, in the configured peripheral interfaces, the high-speed serial computer expansion bus interface PCIE is indispensable.

Specifically, the storage, clock, interface, and the like in the RTL source code generated in step S101 can be mapped to the FPGA chip, and then a two-wire serial bus interface I2C, a universal serial bus interface USB, a video transmission interface VGA, an Ethernet interface Ethernet, a high-speed serial computer expansion bus interface PCIE and other peripheral interfaces are added to the source code of the FPGA chip to construct a system-on-chip of the baseboard management controller.

S403, setting up a development environment of an OpenBMC software framework, and performing cross compiling on the OpenBMC software framework using an RISC-V tool chain of the RISC-V architecture to obtain an OpenBMC system.

Specifically, the development environment of the OpenBMC software framework is set up on the local development platform or device, and the RISC-V tool chain of the RISC-V architecture is used to perform cross compiling on the OpenBMC software framework, so that the OpenBMC system that can run on the baseboard management controller constructed based on the RISC-V system architecture is obtained on the local platform.

Optionally, when compiling the OpenBMC system, the startup mode of the OpenBMC system can be further set as an SPI mode.

Specifically, the startup mode of the OpenBMC system can be set as an SPI mode by modifying RISC-V startup firmware of the RISC-V system architecture.

S404, refreshing the OpenBMC system to a memory.

That is to say, after the OpenBMC system is obtained by executing step S403, the OpenBMC system is refreshed to the memory of the baseboard management controller.

Optionally, the memory adopted in the embodiment of the present disclosure is an SPI memory. Therefore, step S404 specifically includes: refreshing the OpenBMC system to an SPI memory of the RISC-V system architecture.

Optionally, in another embodiment of the present disclosure, after the baseboard management controller is constructed, the construction method may further include:

connecting the baseboard management controller to the server for system integration, and performing system testing according to functions of the baseboard management controller.

Specifically, the high-speed serial computer expansion bus interface PCIE of the baseboard management controller is connected to the southbridge PCH of the server, so that the baseboard management controller is connected to the server for system integration. Then, the functions of the baseboard management controller are tested through corresponding peripheral interfaces according to the functions of the baseboard management controller so as to ensure the reliability of the baseboard management controller.

According to the construction method of a baseboard management controller provided by the embodiment of the present disclosure, the runtime environment of the RocketChip generator is set up, and the RocketChip generator is used to process configuration information in the runtime environment that is set up to generate the soft core source code of the processor; wherein, the configuration information is the configuration information of the processor. Then, a peripheral interface is configured based on the soft core source code of the processor. Wherein, the peripheral interface is connected with the processor through the AXI bus. The development environment of the OpenBMC software framework is set up, and the RISC-V tool chain of the RISC-V architecture is use to perform cross compiling on the OpenBMC software framework to obtain the OpenBMC system, then the OpenBMC system is refreshed to the memory. Therefore, the baseboard management controller is constructed based on the open source RISC-V system architecture instead of the ARM architecture. As a result, the baseboard management controller used by the user is no longer limited by intellectual property rights, and the user can completely autonomously control the baseboard management controller that he/she uses. In addition, the cost of the baseboard management controller is greatly reduced.

Professionals may further realize that the units and algorithm steps of the examples described in the embodiments disclosed in this application can be implemented by electronic hardware, computer software, or a combination thereof, in order to clearly illustrate the interchangeability of hardware and software, in the above description, the composition and steps of each example have been generally described in accordance with the function. Whether these functions are executed by hardware or software depends on the specific application and design constraint conditions of the technical solution. Professionals and technicians can use different methods for each specific application to implement the described functions, but such implementation should not be considered as going beyond the scope of the present disclosure.

The foregoing description of the disclosed embodiments enables those skilled in the art to implement or use the present disclosure. Various modifications to these embodiments will be obvious to those skilled in the art, and the general principles defined herein can be implemented in other embodiments without departing from the spirit or scope of the present disclosure. Therefore, the present disclosure will not be limited to the embodiments shown in this application, but should conform to the widest scope consistent with the principles and novel features disclosed in this application.

1. A baseboard management controller, wherein the baseboard management controller is constructed based on RISC-V system architecture, wherein the baseboard management controller comprises a processor, a memory and a peripheral interface that are connected by an AXI bus;
wherein the memory is configured to store an OpenBMC system which is obtained by cross-compiling of an OpenBMC software framework by an RISC-V tool chain of the RISC-V architecture;
the processor is configured to execute the OpenBMC system stored in the memory, and a soft core source code of the processor is generated by a RocketChip generator.

2. The baseboard management controller according to claim 1, wherein the peripheral interface comprises a two-wire serial bus interface (I2C), a universal serial bus interface (USB), a video transmission interface (VGA), an Ethernet interface (Ethernet), and a high-speed serial computer expansion bus interface (PCIE).

3. The baseboard management controller according to claim 1, wherein the memory comprises an SPI memory of the RISC-V system architecture.

4. The baseboard management controller according to claim 1, wherein a start-up mode of the OpenBMC system is set as an SPI mode.

5. The baseboard management controller according to claim 2, wherein a start-up mode of the OpenBMC system is set as an SPI mode.

6. The baseboard management controller according to claim 3, wherein a start-up mode of the OpenBMC system is set as an SPI mode.

7. The baseboard management controller according to claim 4, wherein the start-up mode of the OpenBMC system being the SPI mode is obtained by modifying RISC-V start-up firmware of the RISC-V system architecture.

8. The baseboard management controller according to claim 5, wherein the start-up mode of the OpenBMC system being the SPI mode is obtained by modifying RISC-V start-up firmware of the RISC-V system architecture.

9. The baseboard management controller according to claim 6, wherein the start-up mode of the OpenBMC system being the SPI mode is obtained by modifying RISC-V start-up firmware of the RISC-V system architecture.

10. A construction method of a baseboard management controller, comprising:
setting up a runtime environment of a RocketChip generator and processing configuration information using the RocketChip generator in the runtime environment that is set up to generate a soft core source code of the processor; wherein the configuration information is configuration information of the processor;
configuring a peripheral interface based on the soft core source code of the processor; wherein the peripheral interface is connected with the processor through an AXI bus;
setting up a development environment of an OpenBMC software framework, and performing cross compiling on the OpenBMC software framework using an RISC-V tool chain of the RISC-V architecture to obtain an OpenBMC system; and
refreshing the OpenBMC system to a memory.

11. The construction method according to claim 10, wherein refreshing the OpenBMC system to a memory comprises:
refreshing the OpenBMC system to an SPI memory of the RISC-V system architecture.

12. The construction method according to claim 10, wherein the peripheral interface comprises a two-wire serial bus interface I2C, a universal serial bus interface USB, a video transmission interface VGA, an Ethernet interface Ethernet, and a high-speed serial computer expansion bus interface PCIE.

13. The construction method according to claim 10, wherein after performing cross compiling on the OpenBMC software framework using an RISC-V tool chain of the RISC-V architecture to obtain an OpenBMC system, the construction method further comprises:
setting a startup mode of the OpenBMC system as an SPI mode.

14. The construction method according to claim 11, wherein after performing cross compiling on the OpenBMC software framework using an RISC-V tool chain of the RISC-V architecture to obtain an OpenBMC system, the construction method further comprises:
setting a startup mode of the OpenBMC system as an SPI mode.

15. The construction method according to claim 12, wherein after performing cross compiling on the OpenBMC software framework using an RISC-V tool chain of the RISC-V architecture to obtain an OpenBMC system, the construction method further comprises:
setting a startup mode of the OpenBMC system as an SPI mode.

16. The construction method according to claim 12, wherein setting a startup mode of the OpenBMC system as an SPI mode comprises:
modifying RISC-V startup firmware of the RISC-V system architecture to enable a startup mode of the OpenBMC system to be an SPI mode.
